(19) United States
(12) Patent Application Publication
(10) Pub. No.: US 2012/0290852 A1
(43) Pub. Date: Nov. 15, 2012

(54) SYSTEM AND METHOD FOR VOLTAGE REGULATOR OPTIMIZATION THROUGH PREDICTIVE TRANSIENT WARNING

(75) Inventors: Johan Rahardjo, Austin, TX (US); Abey K. Mathew, Georgetown, TX (US); Indrani Paul, Round Rock, TX (US)

(73) Assignee: DELL PRODUCTS L.P.

(21) Appl. No.: 13/106,897

(22) Filed: May 13, 2011

(51) Int. Cl. G06F 1/26

(52) U.S. Cl. 713/300

(57) ABSTRACT

In accordance with the present disclosure, a system and method for voltage regulator optimization though predictive transient warning is described. The system may include a transient load, a controller and a voltage regulator. The controller may manage a control state of the transient load and generate a transient notification signal in response to an upcoming transient event at the transient load. The voltage regulator may provide power to the transient load and may change its mode of operation to prepare for the upcoming transient event in response to the transient notification signal.

### TECHNICAL FIELD

The present disclosure relates generally to the operation of computer systems and information handling systems, and, more particularly, to a system and method for voltage regulator optimization though predictive transient warning.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

An information handling system may include numerous components, such as memory, CPUs, and solid state storage, and numerous subsystems incorporating the components, all which require power to operate. In many instances, the components and subsystems may represent transient loads within the information handling system, requiring an increase or decrease in supplied power when operating conditions change. Power supplies and voltage regulators (VRs) may combine to supply power to the transient loads. Providing the necessary power for the transient loads, however, is problematic. For example, because transient loads may cause high overshoot and undershoot voltages in a voltage requirement, meaning the amplitude of voltage change from the steady state output voltage, voltage regulators are typically designed according to the worst case transient response needs, instead of designed to optimal operating conditions. This results in a significant cost burden on VRs. Also, in some instances, accommodating the transient load may require running VRs at a voltage higher than nominal at all or most times, even during low power cycles, resulting in higher power consumption and reduced system-level power efficiency. Additionally, VRs may only detect a transient event in a load, such as a power increase, after the transient event has already occurred, leading to a response delay in increasing the power provided to the load. To compensate for the response delay, the VR may be run at the worst-case non-optimal mode at all times, which also leads to reduced system-level power efficiency, and may require a large number of output capacitors to store the necessary charge to accommodate large transient loads.

### SUMMARY

In accordance with the present disclosure, a system and method for voltage regulator optimization though predictive transient warning is described. The system may include a transient load, a controller and a voltage regulator. The controller may manage a control state of the transient load and generate a transient notification signal in response to an upcoming transient event at the transient load. The voltage regulator may provide power to the transient load and may change its mode of operation to prepare for the upcoming transient event in response to the transient notification signal.

The system and method disclosed herein is technically advantageous because it decreases the overshoot and undershoot voltages in the voltage regulator caused by transient events. By decreasing the overshoot and undershoot voltages, the voltage regulator can be optimized to run in an efficient operating mode, instead of being designed to operate in a worst-case mode to compensate for overshoot and undershoot. Additionally, because the overshoot and undershoot voltages are lower, the transient response time for the voltage regulator may be decreased. Also, by preparing the voltage regulator for an upcoming transient event in the transient load before the transient load occurs, the number of output capacitors in the system can be decreased, because the voltage regulator can supply the required power. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an example power distribution system incorporating aspects of the present invention.

FIG. 2 is an example voltage regulator incorporating aspects of the present invention.

FIGS. 3a and 3b illustrate timing diagrams comparing example transient notification signals, load currents, and output voltages.

FIG. 3c illustrates a timing diagram for an example system without a transient notification signal

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

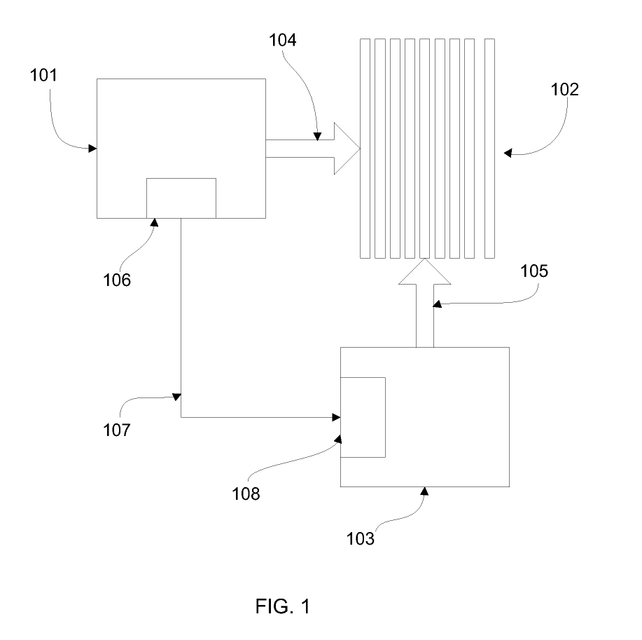

The present invention is directed to the optimization of a VR's response time by preparing a VR ahead of a transient event in a transient load. FIG. 1 illustrates one example subsystem of an information handling system, incorporating aspects of the present invention. FIG. 1 includes a controller 101, a transient load 102, and a VR 103. Transient load 102 includes dual in-line memory modules (DIMMs) but is not limited to DIMMs. Transient load 102 may be one of a number of transient loads in an information handling system, which may operate in numerous modes of operation or control states, defined by the power consumption and activity of the transient loads. Examples include, but are not limited to, memory, central processing units (CPUs), solid-state storage, general-purpose computing on graphics processing units (GPGPU), Network Interface Cards, and other PCIe HBA cards.

Controller 101 may be electrically coupled to transient load 102 via bus 104. The bus 104 may be one of a number of types, such as DDR3 or PCIe, depending on the type of transient load. Likewise, the controller 101 may, for example, be a PCIe Storage controller, depending on the transient load 102. The controller 101 may control the power consumed by the transient load 102 according to one of a number of pre-defined control states. In some information handling systems, the control states may include pre-defined power levels, such as sleep, etc., as defined by the Advanced Power and Configuration Interface (ACPI) specification. The control states may be ranked in an order depending on how much power consumption is required. The controller 101 may receive, for example, commands from other system controllers or processors that cause controller 101 to increase its control state and thereby the power consumed by transient load 102. The increase in power consumed by transient load 102 may comprise a transient event.

Voltage regulator 103 may receive power from a power supply and provide DC regulated power to the transient load 102 through connection 105. The DC regulated power may be limited to a specific DC voltage, depending on the load. For example, the DC voltage may be 1.5V for DIMMs and 3.5V for PCIe storage. When a transient event occurs in transient load 102, the voltage regulator must change current output to accommodate the increased or decreased power requirements of the transient load. Existing VRs change output power only after the control state has been changed and the transient event has occurred, leading to a severe drop in DC voltage and a high undershoot—the drop in DC voltage from the steady state DC voltage output of the VR following a transient event.

According to aspects of the present invention, controller 101 may include a transient load engine 106 that outputs a transient notification signal over communication path 107 to the VR 103 before the transient event occurs. The transient load engine 106 may monitor the activity at controller 101 and indicate an upcoming control state transition. The transient load engine may also implement an algorithm that estimates transient power change based on the change in the number of active ranks—state transitions—driven by the controller and the power associated with each rank. In certain embodiments, the transient load engine 106 may obtain the power requirements of each control state from the DIMM serial presence detect (SPD) data. In other embodiment, the control state information may be passed from system BIOS to controller 101 by being written into a configuration register on controller 101. The control state power information may depend, in part, on the configuration of the transient load 102. For example, the power requirements for a transient load with 3 DIMMs would be less than a transient load with 6 DIMMs. Likewise, the power requirements may depend on the configuration of the specific DIMMs in the transient load. Accordingly, DIMM SPD may contain several key values from each DIMM in transient load 102 by which the step load can be calculated. For example, a step load increase of the transient load may be determined by multiplying the number of ranks in control state the transient load will transition to by the size of the power required for each rank, as determined by the configuration of the transient load.

After the transient load engine 106 generates the transient notification signal, the transient load engine 106 may transmit the transient notification signal to the VR 103. In certain embodiments, the transient notification signal may be an analog step-signal with an amplitude that corresponds to the amplitude of the power change of the upcoming transient event. An Pre-Transient Detect Block 108 in the VR 103 may receive the transient notification signal. The Pre-Transient Detect Block 108 may then compare the amplitude of the transient notification signal to a threshold value. The amplitude of the transient notification signal relative to a threshold value may indicate the amount of additional power which the VR 103 may need to provide, and the Pre-Transient Detect Block 108 may inject an offset into a reference voltage of the VR 103 to trigger a transient state required for the transient event.

In certain embodiments, the size of the offset injected by the Pre-Transient Detect Block 108 may depend on the size of the transient event and may be determined by comparing the transient notification signal with multiple pre-determined thresholds. For example, if the transient notification signal is less that or equal to a first threshold value, the Pre-Transient Detect Block 108 may not inject an offset. If the transient notification signal is greater than the first threshold and less than or equal to a second threshold, the transient event may require a first current level, such as 30 Amps, and the Pre-Transient Detect Block 108 may inject a first offset voltage that corresponds to the first current level. If the transient notification signal is greater than the second threshold and less than or equal to a third threshold, the transient event may require a second current level, such as 60 Amps, and the Pre-Transient Detect Block 108 may inject a second offset voltage, higher than the first offset voltage, that corresponds to the second current level. If the transient notification signal is greater than the third threshold, the transient event may require a third current level, such as 80 Amps, and the Pre-Transient Detect Block 108 may inject a third offset voltage, higher than the second offset voltage, that corresponds to the third current level.

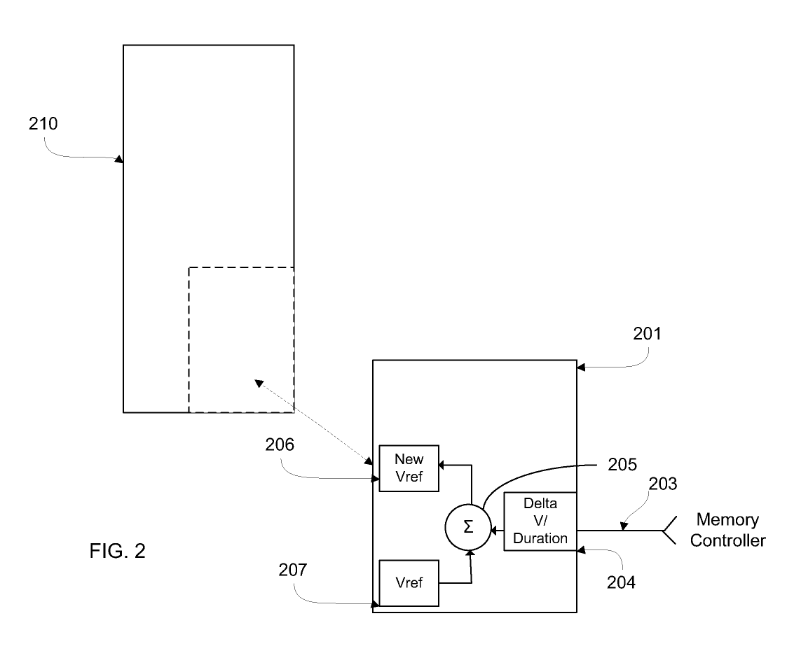

FIG. 2 is an example embodiment of a Pre-Transient Detect Block 201 from a VR 210. The Pre-Transient Detect Block 201 may be located in a pulse-width modulation circuit within VR 210 and may receive the transient notification signal at pin 203 from a controller, such as controller 101 from FIG. 1. The Pre-Transient Detect Block 201 may include a comparator with integrated offset generator 204, which compares the amplitude of the transient notification signal to pre-determined threshold values and produces a delta-v proportional to the threshold level. The delta-v produced by comparator 204 is then added to a reference voltage from block 207 at summation circuit 205, producing a new reference voltage 206. The new reference voltage 206 my then be injected into the VR 210, causing an increase in an error voltage within the VR 210. A voltage regulator controller within VR 210 may recognize the increase in the error voltage as a transient event, responding to the event by increasing the output voltage from the VR 210 before the transient event occurs. Since the output voltage is already rising slightly before the transient event occurs, the undershoot in the output is decreased when the actual transient hits.

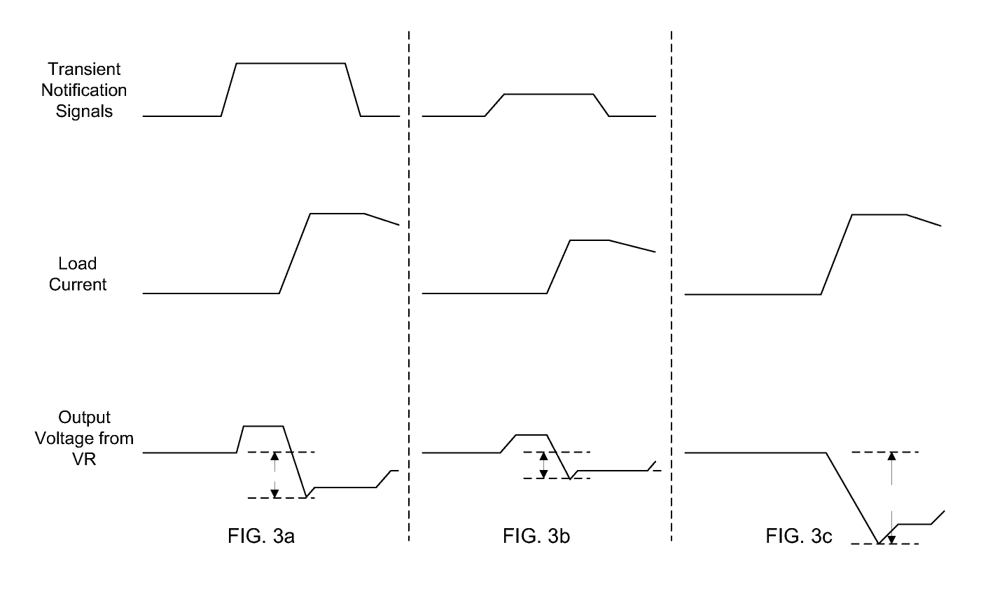

FIGS. 3a and 3b illustrate a timing diagram comparing transient notification signals, load currents at the transient load, and output voltages from the VR. The top row of both FIGS. 3a and 3b are example transient notification signals, which may be generated using a transient load engine, such as element 106 described previously. The middle row of FIGS. 3a and 3b are example load currents, or the current at a transient load, and illustrate transient events via the increase in load current. The bottom row of FIGS. 3a and 3b are example output voltages from VRs, which incorporate an Pre-Transient Detect Block, such as element 108 described earlier. As can be seen, transient notification signals each include a lower amplitude portion and a higher amplitude portion. The lower amplitude portion may correspond to a control state of the transient load that includes a low power state, such as a sleep state. When a controller receives a signal to switch to a different control state, a transient load engine may increase the amplitude of the transient notification signal to indicate the power required in the new control state. The increase in amplitude may depend on the size of the upcoming transient event. For example, the amplitude increase in FIG. 3a is larger that in FIG. 3b, because the transient event in FIG. 3a is to be larger that in FIG. 3b. The change in amplitude of the transient notification signal may trigger a VR to increase the output voltage proportional to the transient load in preparation for the transient event. The amount of increase in the output voltage may correspond to the amount of increase in the amplitude of the transient notification signal. For example, the output voltage in FIG. 3a is higher than in FIG. 3b because the transient notification signal in FIG. 3a has a higher amplitude that the transient notification in FIG. 3b. When the transient event occurs in FIGS. 3a and 3b, the load currents increase quickly, leading to a drop in output voltages. Because the VR is already prepared for the transient events by increasing output voltage, however, the voltage drop is not as server as it would have been otherwise.

FIG. 3c, in contrast, illustrates a information handling system without pre-transient detection and warning. As can be seen, without a transient notification signal, the voltage regulator only responds to the transient event after some delay. Because the voltage regulator is responding only after the transient event occurs, the undershoot, as indicated by the arrows, is much larger than the undershoot in either FIG. 3a or 3b. By decreasing the undershoot using aspects of the present application, power systems can be simplified, including reducing the number of output capacitors needed to provide power to the transient load during a transient event. Other benefits will be apparent to those of ordinary skill in the art viewing this application.

Although the present disclosure has been described in detail, it should be understood that various changes, substitutions, and alterations can be made hereto without departing from the spirit and the scope of the invention as defined by the appended claims.

What is claimed is:

1. A system for providing power to an information handling system, comprising:
a transient load;
a controller, wherein the controller manages a control state of the transient load, and wherein the controller generates a transient notification signal in response to an upcoming transient event at the transient load;
a voltage regulator, wherein the voltage regulator provides power to the transient load, and wherein the voltage regulator prepares for the upcoming transient event in response to the transient notification signal.

2. The system of claim 1, wherein the transient load comprises at least one of a dual in-line memory module (DIMM), a general-purpose computing on graphics processing unit (GPGPU), a storage drive, a PCIe HBA, or a network interface care (NIC).

3. The system of claim 1, wherein a transient load engine in the controller generates the transient notification signal.

4. The system of claim 3, wherein the transient load engine generates the transient response signal according, in part, to the control state of the transient load.

5. The system of claim 1, wherein the transient notification signal is a step-load analog signal.

6. The system of claim 5, wherein the amplitude of the transient notification signal corresponds, in part, to the power required for the transient event.

7. The system of claim 6, wherein a pre-transient detect block in the voltage regulator receives the transient notification signal and determines an offset reference voltage based, in part, on the amplitude of the transient notification signal.

8. The system of claim 7, wherein the pre-transient detect block determines the offset reference voltage by comparing the amplitude of the transient notification signal to at least one threshold value.

9. The system of claim 8, wherein the voltage regulator changes output voltage in response to the injected offset reference voltage.

10. A method for providing power for a transient load in an information handling system, comprising:
sensing with a load controller an upcoming transient event in a transient load;
signaling to a voltage regulator the upcoming transient event; and
preparing the voltage regulator for the upcoming transient event.

11. The method of claim 10, wherein the transient load transient load comprises at least one of a dual in-line memory module (DIMM), a general-purpose computing on graphics processing unit (GPGPU), a storage drive, a PCIe HBA, or a network interface care (NIC).

12. The method of claim 10, wherein a transient load engine in the controller senses the upcoming transient event.

13. The method of claim 12, wherein the transient load engine generates a transient response signal based, at least in part, on a control state of the transient load.

14. The method of claim 13, wherein the transient notification signal is a step-load analog signal.

15. The method of claim 14, wherein the amplitude of the transient notification signal corresponds, in part, to the power required for the upcoming transient event.

16. The method of claim 10, wherein a pre-transient detect block in the voltage regulator receives a transient notification signal generated by the load controller and determines an offset reference voltage based, in part, on the amplitude of the transient notification signal.

17. The method of claim 16, wherein the pre-transient detect block determines the offset reference voltage by comparing the amplitude of the transient notification signal to at least one threshold value.

18. The method of claim 17, wherein the voltage regulator changes output voltage in response the offset reference voltage.

19. A system for providing power in an information handling system, comprising:
a transient load;
a controller including a transient load engine, wherein the transient load engine includes an algorithm for generating a transient response signal in response to an upcoming transient event in the transient load; and
a voltage regulator including a pre-transient detect block, wherein the pre-transient detect block receives the transient response signal, determines a power requirement for the upcoming transient event, and causes the voltage regulator to increase power output to the transient load.

20. The system of claim 19, wherein the size of the increase in power output to the transient load corresponds to the power requirement for the upcoming transient event.
